(19) United States
(12) Patent Application Publication
(10) Pub. No.: US 2016/0321968 A1
(43) Pub. Date: Nov. 3, 2016

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventor: Xiaodan Zhang, Beijing (CN)

(21) Appl. No.: 14/836,545

(22) Filed: Aug. 26, 2015

(30) Foreign Application Priority Data
Apr. 28, 2015 (CN) 201510209658.8

(51) Int. Cl. G09G 3/00; G06F 3/0481; G06F 3/0484; G09G 5/373; G09G 5/38

(52) U.S. Cl. CPC G09G 3/002; G09G 5/373; G09G 5/38; G06F 3/04847; G06F 3/0481; G09G 2320/0613; G09G 2320/08

(57) ABSTRACT

The disclosure provides an information processing method and an electronic device. The method comprises: displaying a first content by a display unit provided in an electronic device; projecting the first content by a projecting unit provided in the electronic device; detecting a first operation and determining a first operation parameter; determining a part of the first content as a second content, based on the first operation parameter; and controlling the projecting unit to adjust a projection of the second content and controlling the display unit to keep its displaying of the second content unchanged.

### CROSS-REFERENCE TO RELATED APPLICATION(S)

This application claims priority to the Chinese Application No. 201510209658.8, filed on Apr. 28, 2015, entitled “INFORMATION PROCESSING METHOD AND ELECTRONIC DEVICE,” which is incorporated herein by reference in its entirety.

### TECHNICAL FIELD

The disclosure generally relates to the technical field of information processing, and more particularly, to an information processing method and an electronic device.

### BACKGROUND

With development of electronic information technology, multiple functions are incorporated into electronic devices. For example, electronic devices are provided with display units comprising display screens on which information is displayed. Meanwhile, they are also provided with projecting units which display information by mean of projecting.

In one scenario, a first user uses a display unit to display information on the display screen while projecting a content of the information displayed on the display unit by using a projecting unit, in order to facilitate viewing for other users. A problem with such scenario is that the projected content in a projected picture generated by the projecting unit may be too large or too small in size. Conventionally, a size of the projected content in the projected picture is changed by synchronously changing the sizes of the displayed contents of the display unit and the projecting unit. Adjusting the display unit together with the projecting unit appears to be inflexible and results in less smart electronic devices and low user satisfaction.

### SUMMARY

In view of the foregoing, embodiments of the disclosure are intended to provide an information processing method and an electronic device.

According to a first aspect of embodiments of the disclosure, there is provided an information processing method. The method comprises:

displaying a first content by a display unit provided in an electronic device;

projecting the first content by a projecting unit provided in the electronic device;

detecting a first operation and determining a first operation parameter;

determining a part of the first content as a second content, based on the first operation parameter;

controlling the projecting unit to adjust a projection of the second content, and controlling the display unit to keep its displaying of the second content unchanged.

Preferably, the method further comprises:

generating first identification information based on the first operation parameter; and

controlling the display unit to display the first identification information,

wherein the first identification information identifies the second content.

Preferably, the method further comprises:

detecting a second operation of moving the first identification information displayed on the display unit; and

moving the first identification information and changing the second content identified by the first identification information, in response to detection of the second operation.

Preferably, the controlling the projecting unit to adjust the projection of the second content comprises:

controlling the projecting unit to enlarge a projection area of the second content; and/or

controlling the projecting unit to shrink the projection area of the second content; and/or

controlling the projecting unit to adjust a projection position of the second content in a projection picture.

Preferably, the detecting the first operation and determining the first operation parameter comprises:

obtaining a position parameter of the first operation on the display unit, and

the determining the second content on which the first operation is performed from the first content based on the first operation parameter comprises:

determining a first display region on the display unit based on the position parameter; and

determining a content displayed in the first display region as the second content.

Preferably, the method further comprises:

determining a degree of adjustment in which the projecting unit adjusts the projection of the second content, based on the first operation parameter,

wherein the controlling the projecting unit to adjust the projection of the second content comprises:

controlling the projecting unit to adjust the projection of the second content based on the degree of adjustment.

Preferably, the determining the degree of adjustment in which the projecting unit adjusts the projection of the second content based on the first operation parameter comprises:

determining the degree of adjustment based on a position parameter of the first operation on the display unit.

Preferably, the determining the degree of adjustment based on the position parameter of the first operation on the display unit comprises:

determining a displacement of the first operation on the display unit, based on a start position and an end position of the first operation on the display unit; and

determining the degree of adjustment based on the displacement.

Preferably, the degree of adjustment includes a projection enlargement factor, a projection shrinking factor or a position displacement.

Preferably, the controlling the projecting unit to adjust the projection of the second content comprises:

controlling the projecting unit to enlarge the projection of the second content and not to project any other part of the first content than the second content.

According to a second aspect of embodiments of the disclosure, there is provided an electronic device comprising:

a display unit configured to display a first content;

a projecting unit configured to project the first content;

a detecting unit configured to detect a first operation and determine a first operation parameter;

a determining unit configured to determine a part of the first content as a second content, based on the first operation parameter; and

a controlling unit configured to control the projecting unit to adjust a projection of the second content and to control the display unit to keep its displaying of the second content unchanged.

Preferably, the electronic device further comprises a generating unit configured to generate first identification information based on the first operation parameter, and

the controlling unit is further configured to control the display unit to display the first identification information,

wherein the first identification information identifies the second content.

Preferably, the detecting unit is further configured to detect a second operation of moving the first identification information displayed on the display unit, and

the display unit is further configured to move the first identification information and change the second content identified by the first identification information, in response to the detection of the second operation.

Preferably, the controlling unit is configured to

control the projecting unit to enlarge a projection area of the second content; and/or

control the projecting unit to shrink the projection area of the second content; and/or

control the projecting unit to adjust a projection position of the second content in a projection picture.

Preferably, the detecting unit is configured to obtain a position parameter of the first operation on the display unit, and

the determining unit is configured to determine a first display region on the display unit based on the position parameter and to determine a content displayed in the first display region as the second content.

Preferably, the determining unit is further configured to determine a degree of adjustment in which the projecting unit adjusts the projection of the second content, based on the first operation parameter, and

the controlling unit is further configured to control the projecting unit to adjust the second content based on the degree of adjustment.

Preferably, the determining unit is further configured to determine the degree of adjustment based on a position parameter of the first operation on the display unit.

Preferably, the determining unit is further configured to

determine a displacement of the first operation on the display unit, based on a start position and an end position of the first operation on the display unit; and

determine the degree of adjustment based on the displacement.

Preferably, the degree of adjustment includes a projection enlargement/shrinking factor or a position displacement.

Preferably, the controlling unit is further configured to control the projecting unit to enlarge the projection of the second content and not to project any other part of the first content than the second content.

### BRIEF DESCRIPTION OF THE DRAWINGS

FIG. 1 is a first schematic flowchart illustrating an information processing method according to an embodiment of the disclosure;

FIG. 2 is a first schematic diagram illustrating an effect of an information processing method according to an embodiment of the disclosure;

FIG. 3 is a second schematic flowchart illustrating an information processing method according to an embodiment of the disclosure;

FIG. 4 is a second schematic diagram illustrating an effect of an information processing method according to an embodiment of the disclosure;

FIG. 5 is a third schematic flowchart illustrating an information processing method according to an embodiment of the disclosure;

FIG. 6 is a first schematic diagram illustrating a first operation according to an embodiment of the disclosure;

FIG. 7 is a second schematic diagram illustrating a first operation according to an embodiment of the disclosure; and

FIG. 8 is a schematic diagram illustrating a structure of an electronic device according to an embodiment of the disclosure.

### DETAILED DESCRIPTION OF EMBODIMENTS

In the following, technical solutions of the disclosure will be explained in further detail in conjunction with accompanying drawings and detailed embodiments.

### First Method Embodiment

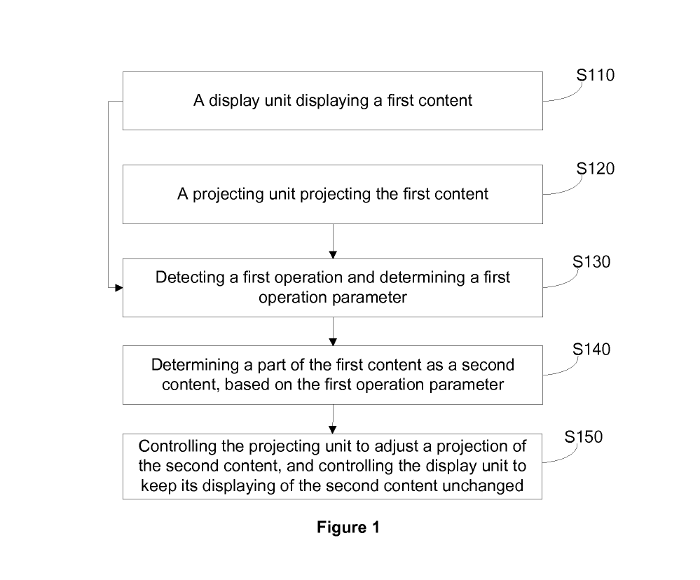

As illustrated in FIG. 1, an information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

According to the embodiment, at step S130, the first operation is detected when the content displayed by the display unit coincides with the content projected by the projecting unit. The first operation may be an operation performed with respect to the display unit, such as a mouse moving operation (which is moving an indicating icon on the display unit with a mouse) and/or a mouse clicking operation. The parameter corresponding to the operation may be the first operation parameter. The first operation may also be an operation of moving a flymouse in the air with respect to the display unit.

When the display unit is an interactive display unit comprising a sensing layer which detects a user operation, the first operation may also be a user operation performed on the interactive display unit. The sensing layer comprised in the interactive display unit may be a touch sensing layer or a floating touch layer. The interactive display unit may include a touch display screen or a floating touch display screen. The user operation may be a sliding operation and/or a clicking operation performed by a user on the display unit.

At step S140, a part of the first content displayed by the display unit is determined as the second content, based on the first operation parameter.

At step S150, the projecting unit adjusts the projection of the second content and the displaying of the second content by the display unit is kept unchanged. As such, user A may know all of the first content by watching the display unit and control the projecting unit to adjust the projection of the second content by means of the first operation, making it convenient for another user to watch the projection picture and know what user A would like to emphasize.

The adjusting the projection of the second content may include operations, such as enlarging a projection area of the second content, shrinking the area of the second content, changing a position of the second content relative to the projection picture, and changing a background color of the second content on the projection picture.

The information processing method according to the embodiment is particularly suitable for information displaying and projecting in scenarios where user A holds a meeting, delivers a lecture or communicates. As such, user A in front of the display unit may watch all of the first content while adjusting the projection by the projecting unit, making it possible for anther user who participates in the meeting, attends the lecture or communicates to watch the second content that user A would like to highlight or hide.

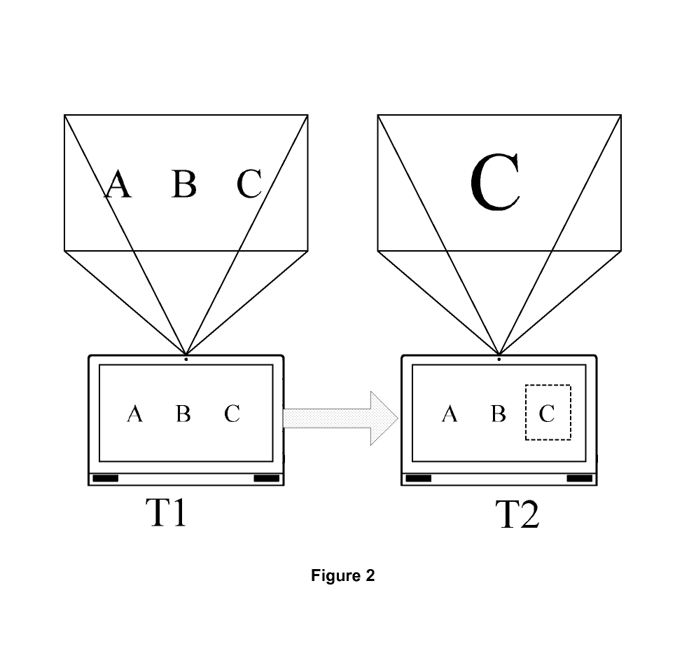

FIG. 2 is a diagram illustrating an effect of displaying and projecting according to the information processing method of the embodiment. A, B and C are displayed on the display unit at both times T1 and T2, while A, B and C are projected on the projection picture at time T1 but only C which is selected as the second content is displayed on the projection picture at time T2. As can be seen from the comparison, C in the projection picture is enlarged at time T2 as compared with time T1.

The embodiment provides an information processing method enables the projecting unit to independently adjust the projection of part of the content displayed on the display unit. As such, the displaying of the projecting unit can be adjusted without synchronously adjusting the displaying of the display unit and the projecting unit. Apparently, software and hardware resources are made better use of, smartness of the electronic device is improved, users' needs of independently controlling the projecting unit to adjust part of the displayed content in certain scenarios are satisfied, and user satisfaction is improved.

### Second Method Embodiment

As shown in FIG. 1, the information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

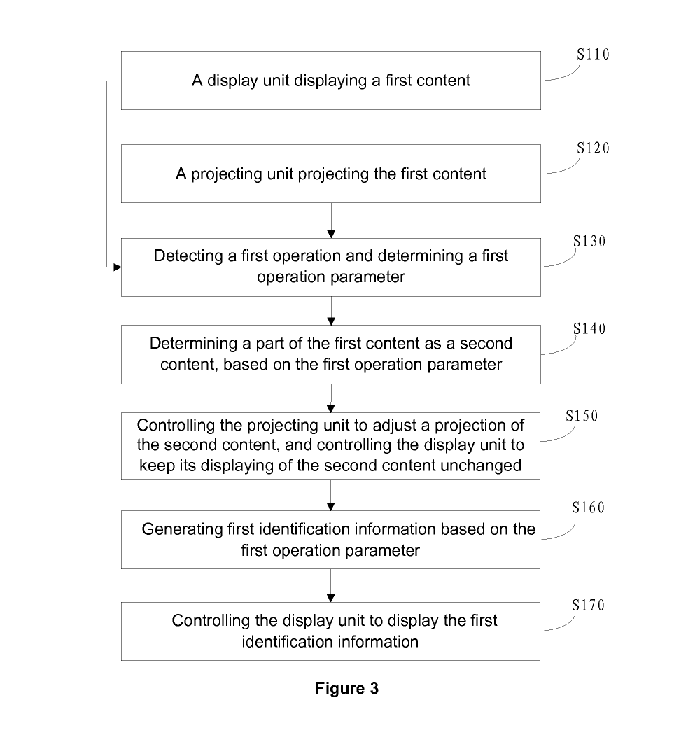

As shown in FIG. 3, the method further comprises:

at step S160, generating first identification information based on the first operation parameter; and

at step S170, controlling the display unit to display the first identification information,

wherein the first identification information identifies the second content.

In the embodiment, the electronic device further generates the first identification information based on the first operation parameter. The first identification information may identify the selected second content. The first identification information may be a block enclosing the second content. The first identification information may further include information serving as an indication, such as an arrow indicating the second content.

The dashed block displayed on the display unit at time T2 as shown in FIG. 2 may be a visual effect of the first identification information.

Typically, the display position of the first identification information on the display unit is close to the display position of the second content on the display unit. As such, it is convenient for a user to locate the second content at the same time when he locates the first identification information.

Generating and displaying the first identification information according to the embodiment makes it convenient for the user to view the second content on the display unit and improves user satisfaction.

### Third Method Embodiment

As illustrated in FIG. 1, the information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

As illustrated in FIG. 3, the method further comprises:

at step S160, generating first identification information based on the first operation parameter; and

at step s170, controlling the display unit to display the first identification information,

wherein the first identification information identifies the second content.

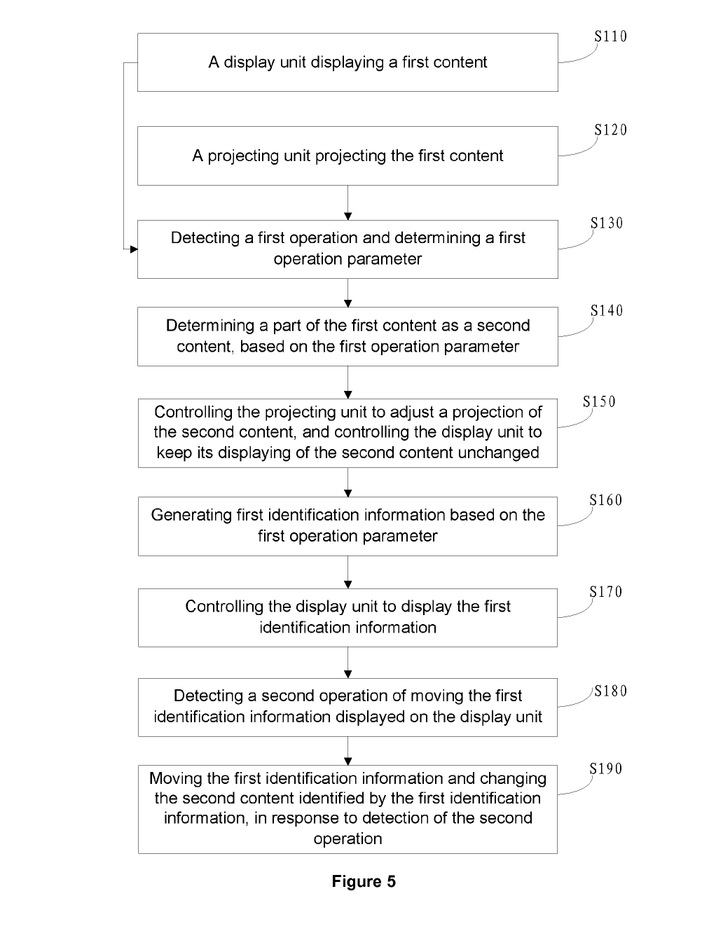

As illustrated in FIG. 5, the method further comprises:

at step S180, detecting a second operation of moving the first identification information displayed on the display unit; and

at step S190, moving the first identification information and changing the second content identified by the first identification information, in response to detection of the second operation.

After the electronic device changes the second content based on the second operation, the projecting unit projects the second content.

The electronic device in the embodiment further responds to a user's operation of dragging the first identification information and makes it convenient for the user to change the identified second content and change the projection of different parts of the first content by the projecting unit through inputting into the electronic device an operation of moving the first identification information.

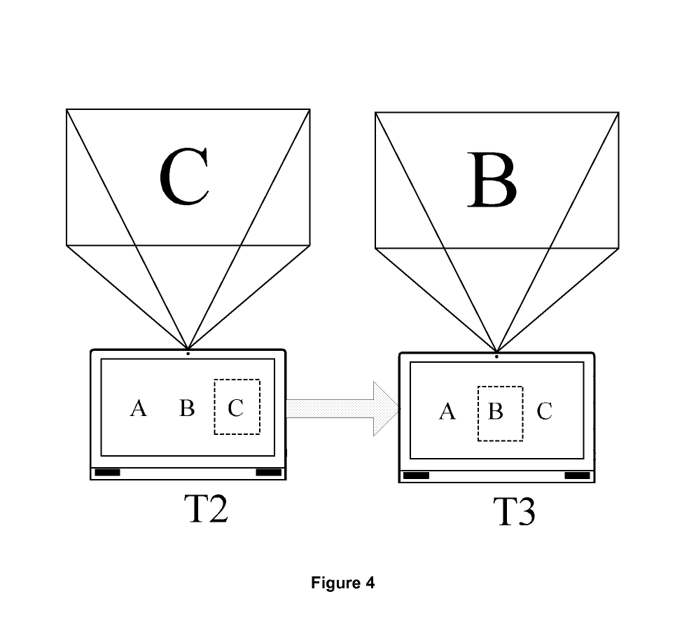

As shown in FIG. 4, at time T2, the second content selected based on the first operation is content C of the first content. At time T3, the second content reselected based on the second operation is content B in the first content. If the projecting unit projects and displays content C in the entire projection picture at time T2, then the projecting unit may project and display content B in the entire projection picture at time T3.

Note that if it is determined at time T2 based on the first operation that a part of the first content is selected to be enlarged and projected, the projecting unit may continue to use a projection parameter used at time T1. What is changed is the content projected by the projecting unit at time T2.

Changing the display position of the first identification information may comprise enlarging a display area of the first identification information on the display unit so as to change the display position of the first identification information. In this case, the second content identified by the first identification information may comprise a previous second content and a newly added part from the first content. The dashed block displayed on the display unit at time T2 as shown in FIG. 4 is a visual effect of the first identification information.

Changing the display position of the first identification information may comprise shrinking the display area of the first identification information on the display unit so as to change the display position of the first identification information. In this case, the second content identified by the first identification information may comprise a part of the previous second content.

Changing the display position of the first identification information may be achieved by moving the first identification information from a first display region to a second display region while keeping the display area of the first identification on the display unit unchanged.

By way of example, when the first identification information is a rectangular block and the second content is the content displayed in the rectangular block, it is apparent that any of enlarging, shrinking or moving the rectangular block could cause a change of information displayed in the rectangular block and hence a reselection of the second content.

The embodiment provides a method for quickly reselecting the second content based on the first identification information. The method has the advantage of ease of implementation, apparently conforms very well to users' usage habits and has the advantage of high user satisfaction.

### Fourth Method Embodiment

As shown in FIG. 1, the information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

The step S150 may comprise at least one of:

controlling the projecting unit to enlarge a projection area of the second content; controlling the projecting unit to shrink the projection area of the second content; and controlling the projecting unit to adjust a projection position of the second content in a projection picture.

The method according to the embodiment lists several manners whereby the projecting unit adjusts the projection of the second content in response to the first operation. The practical implementation of the disclosure is not limited thereto. For example, there may be other adjusting manners in which the projection of the second content is highlighted relative to other parts of the first content by for example changing the background color or font of the second content or displaying the second content in bold or italics while keeping the displaying of the second content on the display unit unchanged. Here, highlighting the projection of the second content may be such that the second content projected by the projecting unit is different in display style or projection parameter from other parts of the first content. For example, when the first content is a document, the second content is projected in one font while the other contents are all projected in another font. As such, it is easier for another user to notice the difference therebetween when watching the projection picture.

### Fifth Method Embodiment

As shown in FIG. 1, the information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

The step S130 may comprise obtaining a position parameter of the first operation on the display unit.

The step S140 may comprise: determining a first display region on the display unit based on the position parameter; and determining a content displayed in the first display region as the second content.

For example, in the case of dragging with a mouse, a parameter representing the position of a moving track of the mouse cursor on the display unit may be the position parameter related to the display unit. As another example, when the display unit is an interactive display unit and a user performs a sliding operation on the interactive display unit, a parameter representing the position of the sliding track is the position parameter related to the display unit.

In the embodiment, the second content is determined based on the position parameter at step S140.

Both the moving track formed by moving the indicating icon on the display unit using the mouse or a remote control and the sliding track corresponding to the user's sliding operation correspond to a region on the display unit. For example, the sliding track is a ring, and the region enclosed by the ring is the first display region. Then, the electronic device determines that the user selects the content displayed in the first display region as the second content.

Such a method for selecting the second content is completely visible to the user and therefore has the advantage of ease of operation by the user.

### Sixth Method Embodiment

As shown in FIG. 1, the information processing method is provided. The method is applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

The method further comprises: determining a degree of adjustment in which the projecting unit adjusts the projection of the second content, based on the first operation parameter.

The step S150 comprises: controlling the projecting unit to adjust the projection of the second content based on the degree of adjustment.

For example, the first operation may include a sliding operation of spreading apart two fingers of a user's hand. The two points farthest from each other during the sliding operation may be used as diagonal vertices of the first display region which is square. As such, the electronic device can determine the second content based on the operation. Meanwhile, the electronic device additionally detects the duration for which the operation is performed on the interactive display unit, and determines the degree for adjusting the second content based on the duration. Specifically, among others, a fast sliding operation results in a large enlargement factor, a slow sliding operation results in a small enlargement factor.

According to another example, the user performs a sliding operation on the display unit to form a sliding track. The ends of the sliding track may be used as diagonal vertices of the first display region which is rectangular or square. Meanwhile, the electronic device further detects whether the sliding track is formed by one-finger sliding or two-finger sliding, so as to determine the degree for adjusting the second content. Specifically, the projecting unit will enlarge the second content in the case of one-finger sliding, while the second content will be shrunk in the case of two-finger sliding. The one-finger sliding and the two-finger sliding can be distinguished based on the number of touches forming the sliding track or the thickness of the sliding track.

In summary, the operation parameter generated by the electronic device according to the embodiment when detecting the first operation can reflect characteristics of the first operation in two or more aspects. As such, it is possible to determine both the second content and the degree for adjusting the second content based on the operation parameter reflecting different characteristics of the first operation.

As mentioned above, the user can control the electronic device to perform two or more operations simultaneously by performing one user operation. Apparently, the electronic device has the advantages of ease of operation by the user and high smartness.

### Seventh Method Embodiment

As shown in FIG. 1, the information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

The method further comprises: determining a degree of adjustment in which the projecting unit adjusts the projection of the second content, based on the first operation parameter.

The step S150 comprises: controlling the projecting unit to adjust the projection of the second content based on the degree of adjustment.

The determining the degree of adjustment in which the projecting unit adjusts the projection of the second content based on the first operation parameter comprises:

determining the degree of adjustment based on a position parameter of the first operation on the display unit.

For example, the first operation may be a sliding operation with respect to the display unit. The region formed by display positions which are centered at a start position of the first operation on the display unit and are at a designated distance from the start position is the first region, and the content displayed in the first region is selected as the second content. A parameter representing the start position of the first operation is the position parameter. The position parameter may further include a parameter representing an end position of the first operation. Then, the degree of adjustment may be determined based on a direction of a line connecting the start position and the end position of the first operation.

For example, the determining the degree of adjustment based on the position parameter may further comprise: determining the degree of adjustment directly based on the end position of the first position, which has a certain correspondence relationship with the degree of adjustment.

According to another example, if the direction of the connecting line is a first direction, then the projecting unit is controlled to enlarge the second content twice. If the direction of the connecting line is a second direction, then the projecting unit is controlled to enlarge the second content three times. The first direction is perpendicular to the second direction. The direction of the connection line is determined based on the position parameter.

In the embodiment, the degree of adjustment includes a projection enlargement factor, a shrinking factor or a position displacement. However, the practical implementation of the disclosure is not limited thereto. For example, if the projecting unit adds a background color for the second content, then the degree of adjustment may be the shade of the added background color.

In practical implementation, the information processing method according to the disclosure may directly adjust the projection of the second content, instead of determining the degree of adjustment based on the first operation parameter. For example, when the first operation is an operation for controlling the projecting unit to enlarge the second content, the electronic device enlarges the projection of the second content after determining the second content, so that the second content is displayed in such a manner that the projection picture is filled with the second content.

In summary, the electronic device according to the embodiment can determine both the second content and the degree of adjustment based on the position parameter corresponding to the first operation. Accordingly, it has the advantage of ease of operation by the user.

### Eighth Method Embodiment

As shown in FIG. 1, the information processing method is provided. The method may be applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

The method further comprises: determining a degree of adjustment in which the projecting unit adjusts the projection of the second content, based on the first operation parameter.

The step S150 comprises: controlling the projecting unit to adjust the projection of the second content based on the degree of adjustment.

The determining the degree of adjustment based on the position parameter of the first operation on the display unit comprises:

determining a displacement of the first operation on the display unit, based on a start position and an end position of the first operation on the display unit; and

determining the degree of adjustment based on the displacement.

Again, taking the moving track or sliding track as an example, the start position of the moving track or sliding track is the start position of the operation, and the end position of the moving track or sliding track is the end position of the operation. In the embodiment, the displacement is calculated based on the start position and the end position of the operation. Then, the degree of adjustment is determined based on the amount of the displacement.

For example, the larger the displacement is, the larger the enlargement factor or the shrinking factor is. The smaller the displacement is, the smaller the enlargement factor or the shrinking factor is.

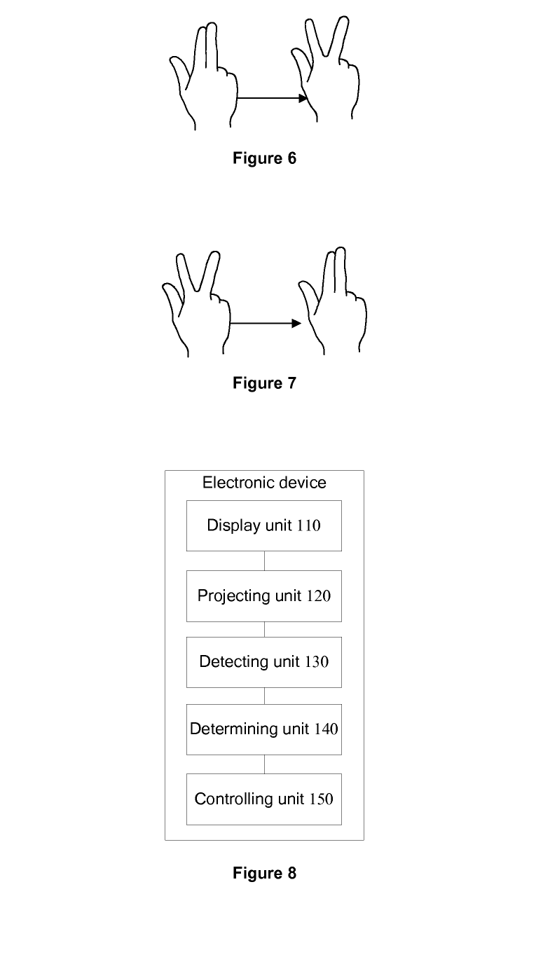

FIG. 6 illustrates a type of first operation called two-finger spread-apart operation, which is to laterally spread apart two fingers placed together. The operation itself may be used to select the second content as described in the above embodiments. Meanwhile, the displacement of the two fingers during the spread-apart operation may be additionally used to determine the degree of adjustment. In detailed implementation, because the two fingers placed together are spread apart, a type parameter is also determined for the adjustment of the second content by the projecting unit. According to the adjustment type parameter, the electronic device will enlarge the projection of the second content.

FIG. 7 illustrates another type of first operation called two-finger pinch-together operation, which is to change two fingers from a state of being spread apart to a state of being pinched together. The operation itself may be used to select the second content as described in the above embodiments. Meanwhile, the displacement of the two fingers during the pinch-together operation may be additionally used to determine the degree of adjustment. In detailed implementation, because the two fingers change from the state of being spread apart to the state of being pinched together, a type parameter is also determined for the adjustment of the second content by the projecting unit. According to the adjustment type parameter, the electronic device will shrink the projection of the second content.

In summary, the information processing method according to the embodiment can determine multiple parameters for the adjustment of the projection of the second content, based on one user operation. Accordingly, user operation is simplified, and smartness of the electronic device and user satisfaction are improved.

### Ninth Method Embodiment

As shown in FIG. 1, the embodiment provides an information processing method which is applied to an electronic device comprising a display unit. The electronic device is provided with a projecting unit which is operable to project a content displayed on the display unit. The method may comprise:

at step S110, the display unit displaying a first content;

at step S120, the projecting unit projecting the first content;

at step S130, detecting a first operation and determining a first operation parameter;

at step S140, determining a part of the first content as a second content, based on the first operation parameter;

at step S150, controlling the projecting unit to adjust a projection of the second content, and controlling the display unit to keep its displaying of the second content unchanged.

The step S150 comprises: controlling the projecting unit to enlarge the projection of the second content and not to project any other part of the first content than the second content.

The projecting unit may project the first content completely at a third time, and project the second content in such a manner that the original projection region is filled with the second content at a fourth time after the third time. As such, the projection of the second content is enlarged, and other parts of the first content than the second content are not projected. Accordingly, the second content may be hided.

The controlling the projecting unit to enlarge the projection of the second content and not to project any other part of the first content than the second content may be specifically implemented at least in the following manner:

At a first time, image data of the first content is provided to a display module of the projecting unit. The display module displays the first content. After transmitting through the display module, light rays from a projecting light source form a projection picture including the first content. At a second time, only projection data of the second content is provided to the display module. The display module refreshes its displaying based on the image data of the second content. After transmitting through the display module, the light rays from the projecting light source form a projection picture including only the second content. The image data of the second content at the second time is enlarged as compared with the first time. For example, supposing a projection object A on the display module, which corresponds to the second content, occupies 4 projection pixels of the display module at the first time, if the projecting unit needs to be controlled to enlarge the projection area of the second content four times, then the projection object A on the display module would occupy 16 projection pixels at the second time.

If the display module reads the image data from a buffer region A for displaying, then at the second time the electronic device could delete from the buffer region A other data than the image data corresponding to the second content and meanwhile enlarge the image data of the second content. As such, the display module displays the image data after reading the image data from the buffer region A. The effect of enlarging the projection of the second content and not projecting other contents can be achieved. In order to back up the image data of the first content, it is also possible to store the image data of the first content in a storage region B before deleting other data than the image data corresponding to the second content.

Note that the display module in the embodiment is different from the display unit in that the content displayed by the display unit is visible to the user while the display module is inside the electronic device and the content it displays is not visible to the user.

In summary, the embodiment provides an information processing method, which is able to enlarge a part of a content projected at a previous time and hide other parts of the content while keeping the display area of the display unit unchanged. As such, it is convenient for a user to highlight or enlarge a certain part of content in various occasions such as teaching, meeting, lecturing. Thus, different user requirements are satisfied. The electronic device has the advantages of high smartness and high user satisfaction.

### First Device Embodiment

As illustrated in FIG. 8, an electronic device is provided. The electronic device comprises a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The display unit 110 according to the embodiment may be any kind of display structure that includes a display screen enabling the electronic device to display information, such as a liquid crystal display screen, an electronic ink display screen, a plasma display screen, an organic light emitting diode display screen or the like.

The projecting unit 120 may specifically comprise a projection light source, a display module, a projection lens and the like. The projection light source emits projection light rays. The display module displays the projected content, and the projection light rays transmit through the display module. The projection lens diverges the projection light rays. After the above components have performed their processing, projection information including text and/or an image can be watched in the projection region.

The electronic device according to the embodiment may be provided with the projecting unit by including the projecting unit 120 as an integral part of the electronic device in such a manner that the projecting unit 12 is located inside the housing of the electronic device or by connecting the projecting unit 120 to the electronic device 120 in a wired or a wireless manner. Then, the electronic device is configured with information related to the projecting unit 120 for controlling operation of the projecting unit 120. Specifically, the controlling the operation of the projecting unit 120 comprises controlling various projection parameters, such as the content projected by the projecting unit 120, the brightness of the projected content, etc.

The detecting unit 130 may include various sensors that can detect the first operation, including not only a wired mouse, a keyboard, a wireless mouse, a remote control and a remote control handle that can detect a user operation, but also a human machine interactive interface that can detect a user operation such as a touch display screen, a floating touch display screen, or the like. In detailed implementation, the detecting unit may also include an audio detecting unit which obtains the first operation parameter by detecting an audio input from the user. In detailed implementation, the first operation may be an operation resulting from a movement of a user's hand (such as a gesture operation) or an operation performed with a wired or wireless mouse. As such, it is easier for the electronic device to determine the second content based on the first operation parameter corresponding to the operation.

The determining unit 140 and the controlling unit 150 may specifically comprise various processors, all of which have information processing functions and are able to function as the determining unit 140 and the controlling unit 150 by executing particular codes. The processors may be devices having information processing functions, such as central processing units (CPUs), micro processing units (MCUs), application processors (APs), digital signal processor (DSPs) or programmable arrays.

In summary, the embodiment provides an electronic device as a hardware product whereby the above method embodiments can be implemented. Likewise, the projecting unit can be controlled to adjust the projection of the selected content based on the operation on the display unit, while the display unit keeps its displaying of the selected content unchanged. Here, the selected content is the second content mentioned above. Accordingly, software and hardware resources are made better use of to satisfy user requirements, and smartness of the electronic device and user satisfaction are improved.

### Second Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The electronic device further comprises a generating unit configured to generate first identification information based on the first operation parameter.

The controlling unit 150 is further configured to control the display unit 110 to display the first identification information,

wherein the first identification information identifies the second content.

Also, the generating unit may specifically comprise a processor, which has an information processing function and is able to perform information processing, such as generating the first identification information based on the first operation parameter. As for related description of the first identification information, reference can be made to the above-described method embodiments. For example, the first identification information may be the dashed block displayed in the display unit as shown in FIGS. 2 and 4.

By adding the generating unit and reusing the controlling unit 150 to control the displaying of the first identification information, the embodiment makes it easier for a user to exactly identify the second content whose projection is presently adjusted by the projecting unit 120, based on the first identification information, when viewing information on the display unit 110. Apparently, software and hardware resources are made better use of, and smartness of the electronic device and user satisfaction are improved.

### Third Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The electronic device further comprises a generating unit configured to generate first identification information based on the first operation parameter.

The controlling unit 150 is further configured to control the display unit 110 to display the first identification information,

wherein the first identification information identifies the second content.

The detecting unit 130 is further configured to detect a second operation of moving the first identification information displayed on the display unit.

The display unit 110 is further configured to move the first identification information and change the second content identified by the first identification information, in response to the detection of the second operation.

In the embodiment, the detecting unit is further configured to detect the second operation. In detailed implementation, the second operation may be of the same type as the first operation. For example, both the first and the second operations are mouse operations, operations performed on a touch screen or a floating touch screen, or gesture operations captured by a camera.

By reusing the detecting unit 13 to detect the second operation and configuring the display unit 10 to move the first identification information, the embodiment enables the second content to be reselected and the projecting unit 120 to change the information content it adjusts. As such, the selection of the second content is simply implemented. Moreover, the change of the representation of the second contention is visible, thereby facilitating a user's viewing. Accordingly, user satisfaction is improved.

### Fourth Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The controlling unit 150 is configured to control the projecting unit 120 to enlarge a projection area of the second content, and/or control the projecting unit to shrink the projection area of the second content, and/or control the projecting unit to adjust a projection position of the second content in a projection picture.

On the basis of the above embodiment, this embodiment further provides at least three manners whereby the controlling unit 150 controls the projecting unit 120 to adjust the projection of the second content.

The electronic device according to the embodiment enables at least one of enlarging the projection area of the second content, shrinking the projection area of the second content and adjusting the projection position of the second content in the projection picture, and has the advantages of ease of implementation and simple structure.

### Fifth Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The detecting unit 130 is configured to obtain a position parameter of the first operation on the display unit.

The determining unit 140 is configured to determine a first display region on the display unit based on the position parameter and to determine a content displayed in the first display region as the second content.

In the embodiment, the detecting unit 130 obtains the specific position parameter corresponding to the first position on the display unit, such as a touch coordinate corresponding to the first operation, a position where a mouse is clicked, or start and end positions of a movement of the mouse, etc. The determining unit 140 further determines the first display region based on the position parameter, and takes the content presently displayed in the first display region as the second content. The first display region is a part of the display region of the display unit.

Apparently, the electronic device according to the embodiment can determine the second content based on the position parameter of the first operation, and has the advantages of simple structure and ease of implementation.

### Sixth Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The determining unit 140 is further configured to determine a degree of adjustment in which the projecting unit 120 adjusts the projection of the second content, based on the first operation parameter.

The controlling unit 150 is further configured to control the projecting unit 120 to adjust the second content based on the degree of adjustment.

In the embodiment, the determining unit further determines the degree of adjustment based on the first operation parameter. The degree of adjustment may include, among other parameters, an enlargement factor, a shrinking factor, or skewness of text.

As for the hardware structure of the determining unit 140 and the control unit 150 in the embodiment, reference can be made to the above device embodiments. However, the determining unit 140 in the embodiment is further reused to determine the degree of adjustment, and the controlling unit 150 further controls the degree for adjusting the second content based on the degree of adjustment. Apparently, software and hardware resources are made better use of, and smartness of the electronic device is improved. Moreover, the electronic device can be controlled to perform different operations, by performing one user operation. Apparently, the electronic device has the advantage of ease of user control.

### Seventh Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The determining unit 140 is further configured to determine a degree of adjustment in which the projecting unit 120 adjusts the projection of the second content, based on the first operation parameter.

The controlling unit 150 is further configured to control the projecting unit 120 to adjust the second content based on the degree of adjustment.

The determining unit 140 is further configured to determine the degree of adjustment based on a position parameter of the first operation on the display unit 110.

On the basis of the former device embodiment, the electronic device according to this embodiment further requires the determining unit 140 to determine the degree of adjustment based on the position parameter of the first operation on the display unit 110. Among others, the position parameter may include the start position and the end position of the first operation. As for the hardware structure of the determining unit 140, reference can be made to the above device embodiment and repetition will not be made here.

In the embodiment, the degree of adjustment includes a projection enlargement/shrinking factor or a position displacement. However, the practical implementation of the disclosure is not limited thereto. For example, if the projecting unit 110 adds a background color for the second content, then the degree of adjustment may be the shade of the added background color.

In summary, the electronic device according to the embodiment can provide a hardware implementation for the information processing method according to the seventh method embodiment. Also, it has the advantages of high smartness and high user satisfaction.

### Eighth Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The determining unit 140 is further configured to determine a degree of adjustment in which the projecting unit 120 adjusts the projection of the second content, based on the first operation parameter.

The controlling unit 150 is further configured to control the projecting unit 120 to adjust the second content based on the degree of adjustment.

The determining unit 140 is further configured to determine the degree of adjustment based on a position parameter of the first operation on the display unit 110.

The determining unit 140 is further configured to determine a displacement of the first operation on the display unit, based on a start position and an end position of the first operation on the display unit, and determine the degree of adjustment based on the displacement.

On the basis of the former device embodiment, this embodiment firstly determines the displacement between the start position and the end position of the first operation based on the start position and the end position of the first operation and then determines the degree of adjustment based on the displacement, and has the advantage of ease of implementation. In detailed implementation, the determining unit 14 may comprise a calculator or a processor having a computation function. As such, the displacement can be obtained through operations according to an operational function relation characterizing position parameters such as coordinates of the start position and the end position of the first operation.

Apparently, the electronic device according to the embodiment enables the degree of adjustment to be simply determined based on the displacement of the first operation, and has the advantages of simple structure and ease of implementation.

### Ninth Device Embodiment

As illustrated in FIG. 8, it is provided the electronic device comprising a display unit 110. The electronic device is provided with a projecting unit 120 which is operable to project a content displayed on the display unit.

The display unit 110 is configured to display a first content.

The projecting unit 120 is configured to project the first content.

The electronic device further comprises:

a detecting unit 130 configured to detect a first operation and determine a first operation parameter;

a determining unit 140 configured to determine a part of the first content as a second content, based on the first operation parameter;

a controlling unit 150 configured to control the projecting unit to adjust a projection of the second content and to control the display unit to keep its displaying of the second content unchanged.

The controlling unit 150 is further configured to control the projecting unit to enlarge the projection of the second content and not to project any other part of the first content than the second content.

As described above, the projecting unit 120 may comprise a projecting light source, a display module and a projecting lens, etc. In the electronic device according to the embodiment, the controlling unit 150 controls the display module to display only the second content after it selects the second content. As such, only the second content will be projected, thereby achieving the effect of enlarging the second content and meanwhile hiding other contents than the second content.

The electronic device according to the embodiment can provide a hardware implementation for the ninth method embodiment, and has the advantages of high smartness and high user satisfaction.

It shall be appreciated that the devices and methods disclosed by the embodiments given here can be implemented in other manners. The above described device embodiments are just illustrative. For example, the division of the device into units is just made in terms of their logical functioning. In practical implementation, there may be other manners for dividing the device. For example, multiple units or components may be combined or may be integrated into another system, or some features may be omitted or not implemented. In addition, direct or indirect couplings or communication connections as illustrated or discussed may be via some interfaces, and indirect couplings or communication connections between devices or units may be electrical, mechanical or in other forms.

Units described above as separate components may or may not be physically separate. A component illustrated as a unit may or may not be a physical unit. That is, it may be located in one place or distributed over multiple network units. The object of the embodiment solution may be achieved by selecting some or all of the units according to practical demands.

Additionally, the functional units in the embodiments of the disclosure may be integrated into one processing module or implemented as separate units, or two or more of them may be integrated into one unit. The integrated unit may be implemented in hardware or in the form of hardware plus software functional units.

As those skilled in the art will appreciate, all or some of the steps of the above method embodiments may be implemented in hardware related to program instructions. The program may be stored in a computer-readable medium. When the program is executed, the steps of the above method embodiments are performed. The medium includes any kind of medium that can store program codes, such as a removable storage device, a read-only memory (ROM), a random access memory (RAM), a disk or an optical disc.

The above contents are just detailed embodiments of the disclosure and are not intended to limit the disclosure. Any alterations or replacements that can be readily conceived of by those skilled in the art within the spirit and scope of the disclosure shall be encompassed by the protection scope of the disclosure. Thus, the protection scope of the disclosure is intended to be defined by the appended claims.

What is claimed is:

1. An information processing method, comprising:
displaying a first content by a display unit provided in an electronic device;
projecting the first content by a projecting unit provided in the electronic device;
detecting a first operation and determining a first operation parameter;
determining a part of the first content as a second content, based on the first operation parameter;
controlling the projecting unit to adjust a projection of the second content, and controlling the display unit to keep its displaying of the second content unchanged.

2. The method according to claim 1, further comprising:
generating first identification information based on the first operation parameter; and
controlling the display unit to display the first identification information,
wherein the first identification information identifies the second content.

3. The method according to claim 2, further comprising:
detecting a second operation of moving the first identification information displayed on the display unit; and
moving the first identification information and changing the second content identified by the first identification information, in response to the detection of the second operation.

4. The method according to claim 1, wherein the controlling the projecting unit to adjust the projection of the second content comprises:
controlling the projecting unit to enlarge a projection area of the second content; and/or
controlling the projecting unit to shrink the projection area of the second content; and/or
controlling the projecting unit to adjust a projection position of the second content in a projection picture.

5. The method according to claim 1, wherein
the detecting the first operation and determining the first operation parameter comprises:
obtaining a position parameter of the first operation on the display unit, and
the determining the second content on which the first operation is performed from the first content based on the first operation parameter comprises:
determining a first display region on the display unit based on the position parameter; and
determining a content displayed in the first display region as the second content.

6. The method according to claim 1, further comprising:
determining a degree of adjustment in which the projecting unit adjusts the projection of the second content, based on the first operation parameter,
wherein the controlling the projecting unit to adjust the projection of the second content comprises:
controlling the projecting unit to adjust the second content based on the degree of adjustment.

7. The method according to claim 6, wherein the determining the degree of adjustment in which the projecting unit adjusts the projection of the second content based on the first operation parameter comprises:
determining the degree of adjustment based on a position parameter of the first operation on the display unit.

8. The method according to claim 7, wherein the determining the degree of adjustment based on the position parameter of the first operation on the display unit comprises:
determining a displacement of the first operation on the display unit, based on a start position and an end position of the first operation on the display unit; and
determining the degree of adjustment based on the displacement.

9. The method according to claim 6, wherein the degree of adjustment includes a projection enlargement factor, a projection shrinking factor or a position displacement.

10. The method according to claim 1, wherein the controlling the projecting unit to adjust the projection of the second content comprises:
controlling the projecting unit to enlarge the projection of the second content and not to project any other part of the first content than the second content.

11. An electronic device comprising
a display unit configured to display a first content,
a projecting unit configured to project the first content,
a detecting unit configured to detect a first operation and determine a first operation parameter;
a determining unit configured to determine a part of the first content as a second content, based on the first operation parameter;
a controlling unit configured to control the projecting unit to adjust a projection of the second content and to control the display unit to keep its displaying of the second content unchanged.

12. The electronic device according to claim 11, wherein
the electronic device further comprises a generating unit configured to generate first identification information based on the first operation parameter, and
the controlling unit is further configured to control the display unit to display the first identification information,
wherein the first identification information identifies the second content.

13. The electronic device according to claim 12, wherein
the detecting unit is further configured to detect a second operation of moving the first identification information displayed on the display unit, and
the display unit is further configured to move the first identification information and change the second content identified by the first identification information, in response to the detection of the second operation.

14. The electronic device according to claim 12, wherein the controlling unit is configured to
control the projecting unit to enlarge a projection area of the second content; and/or
control the projecting unit to shrink the projection area of the second content; and/or
control the projecting unit to adjust a projection position of the second content in a projection picture.

15. The electronic device according to claim 11, wherein
the detecting unit is configured to obtain a position parameter of the first operation on the display unit, and
the determining unit is configured to determine a first display region on the display unit based on the position parameter and to determine a content displayed in the first display region as the second content.

16. The electronic device according to claim 11, wherein
the determining unit is further configured to determine a degree of adjustment in which the projecting unit adjusts the projection of the second content, based on the first operation parameter, and
the controlling unit is further configured to control the projecting unit to adjust the second content based on the degree of adjustment.

17. The electronic device according to claim 16, wherein the determining unit is further configured to determine the degree of adjustment based on a position parameter of the first operation on the display unit.

18. The electronic device according to claim 17, wherein the determining unit is further configured to
determine a displacement of the first operation on the display unit, based on a start position and an end position of the first operation on the display unit; and
determine the degree of adjustment based on the displacement.

19. The electronic device according to claim 16, wherein the degree of adjustment includes a projection enlargement/shrinking factor or a position displacement.

20. The electronic device according to claim 11, wherein the controlling unit is further configured to control the projecting unit to enlarge the projection of the second content and not to project any other part of the first content than the second content.
